(19) United States
(12) Patent Application Publication
(10) Pub. No.: US 2006/0270262 A1
(43) Pub. Date: Nov. 30, 2006

(54) HOUSING SEAL FOR A PLUG-TYPE CONNECTION

(76) Inventors: Martin Schmidt, Lubbecke (DE); Andreas Nass, Warmsen (DE); Ullrich Dorniok, Bremen (DE)

Correspondence Address: HAYES, SOLOWAY P.C., 3450 E. SUNRISE DRIVE, SUITE 140, TUCSON, AZ, 85718, US

(21) Appl. No.: 11/382,528

(22) Filed: May 10, 2006

(30) Foreign Application Priority Data
May 27, 2005 (DE) 20 2005 008 288.0

(51) Int. Cl. H01R 13/52

(52) U.S. Cl. 439/271

(57) ABSTRACT

The invention proposes a seal for a plug-type connection that is composed of a connector and a mating connector and respectively features a receptacle, wherein a ring seal fixed on the receptacle features an axial sealing region and a radial sealing region.

### FIELD OF THE INVENTION

The invention pertains to a housing seal for a plug-type connection that is composed of a connector and a mating connector and respectively features a receptacle.

### BACKGROUND OF THE INVENTION

A housing seal of this type is required for realizing a seal relative to the environment when producing a plug-type connection between a connector and a mating connector with a short-stroke interlocking movement, and for ensuring that forces acting upon the connector laterally do not result in any leaks. With respect to seals for housing parts, one distinguishes between radially and axially acting seals. Either the radial or the axial principle is favored depending on the manner in which the housing parts are interlocked.

For example, radially acting seals are used in bayonet or push-pull interlocking mechanisms while axially acting seals are used in connection with housing parts that are clamped together in the axial direction with the aid of a clamp or a screw connection.

A seal that acts in the axial direction only has the disadvantage, for example, that leaks occur at least in instances in which lateral, asymmetrically acting forces are exerted upon one of the housing parts such that the seal is compressed on one side and a gap is created on the other side.

### DESCRIPTION OF THE RELATED ART

DE 201 06 752 U1 discloses a radial seal for electric plug-type connections with a packed sealing gap with broad tolerances, wherein a hollow space is arranged in the interior of the seal.

### SUMMARY OF THE INVENTION

Consequently, the invention is based on the objective of developing a housing seal for an electric plug-type connection, the effective sealing function of which relative to environmental influences is also preserved when the connector is subjected to lateral forces.

This objective is attained in that a ring seal fixed on the receptacle features an axial sealing region and a radial sealing region.

The plug-type connection shown is produced with short-stroke movements that cannot subject a housing seal to excessive axial forces. According to the invention, a ring seal of a flexible material is provided for producing a tight seal with relatively low forces by inserting the advantageously shaped ring seal into the sealing region between the receptacles of a connector and a mating connector, wherein an axial and a radial sealing region are advantageously combined in one ring seal.

Several variations of ring seals may be considered for this purpose, wherein said ring seals are either fixed on one of the receptacles by means of a tongue-and-groove system or glued to the receptacle.

The radial seal is always realized in accordance with the same principle, in which the radial portion of the ring seal is chosen slightly wider than the spacing between the two receptacles in the immediate sealing region.

When producing the axial seal, the two receptacles are practically pushed toward one another until a “zero” spacing relative to the seal is achieved, wherein the axial sealing region is compressed by interlocking the connectors.

A first variation is provided with the groove for attaching and fixing the ring seal to a peripheral collar provided on one of the receptacles.

An outwardly directed rounding or bead is provided in this case and compressed by the second receptacle when the plug-type connection is produced.

A second variation is provided with a slope on the outer receptacle that serves for compressing the ring seal arranged between the two receptacles.

A third variation features peripheral sealing lips that extend in the radial as well as the axial direction on the base body of the ring seal and are also compressed at or before the time at which the connectors are interlocked.

A fourth variation features a profile that is angled in an L-shaped fashion, wherein one side of said profile is realized slightly bulgier while the axial seal is produced by means of a peripheral sealing lip.

### BRIEF DESCRIPTION OF THE DRAWINGS

One embodiment of the invention is illustrated in the figures and described in greater detail below. The figures show:

FIG. 1 is a plug-type connection between a connector and a mating connector;

FIG. 2 is a first variation of a ring seal with a rounding;

FIG. 3 is a second variation of a ring seal with a slope;

FIG. 4 is a third variation of a ring seal with integrated sealing lips, and

FIG. 5 is a fourth variation with an L-shaped ring seal.

### DESCRIPTION OF THE PREFERRED EMBODIMENT

With respect to the following description of the figures, it should be noted that all variations of the ring seal 10 and of the receptacles 20, 30 are identified by the same reference symbols for reasons of simplicity, wherein special functions, however, are identified by different reference symbols.

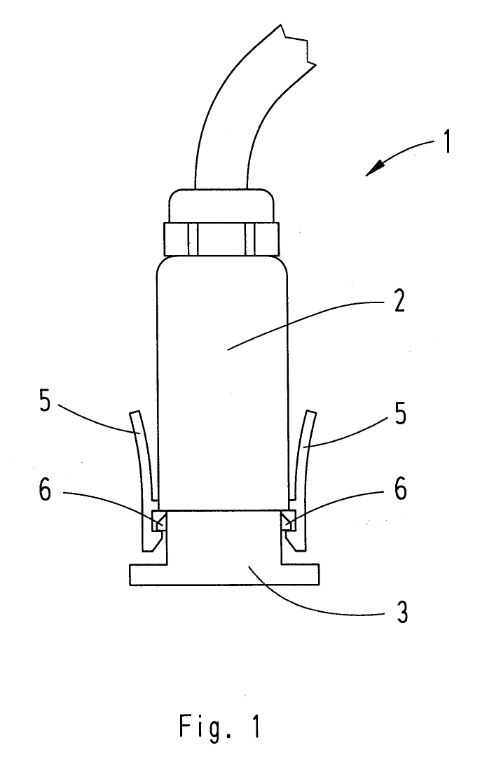

FIG. 1 shows an overview of a plug-type connection 1 between two connector housings, wherein the connector 2 to be connected is joined with a mating connector 3 to be flanged thereon.

The two connectors are interlocked by means of two locking arms 5 on the connector 2 that are engaged with hooks 6 of the mating connector 3.

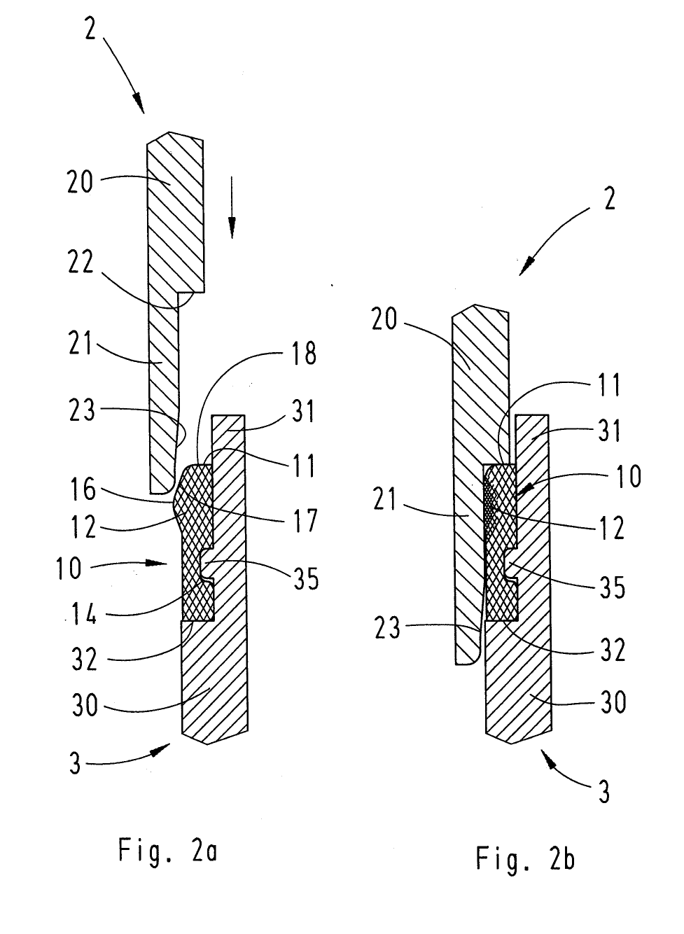

FIG. 2 shows an enlarged sectional representation of a first variation of a ring seal 10 that serves for producing a seal relative to the environment when the two connector housings 2, 3 with the receptacles 20, 30 are connected to one another.

FIGS. 2a and 2b show different stages of the connecting process, during which the seal is simultaneously produced.

FIG. 2a shows the non-connected position of the receptacle 20 above the receptacle 30.

The receptacle 20 features a collar 21, on the end of which a slope 23 is arranged, wherein the collar begins at an inner end stop 22 of the receptacle.

The receptacle 30 of the mating connector 3 also features a collar 31 that begins at an end stop 32 in the receptacle wall. This receptacle features an outwardly directed peripheral collar 35, on which the ring seal 10 is fixed with a groove 14 arranged therein.

This connector is designed such that the ring seal adjoins the end stop 32 with one narrow edge in order to fulfill the requirement of sealing the axial region.

The ring seal is provided with a rounding 16 that points radially outward and has a larger diameter than the remaining outside wall of the ring seal that extends parallel to the receptacle wall.

When the two receptacles are connected to one another, the slope 23 of the receptacle 20 initially comes in contact with the rounding 16 of the ring seal 10 and compresses the elastic material until the receptacle 20 contacts the free end 18 of the ring seal with the end stop 22.

Since both connectors are subsequently interlocked, the end stop 22 of the receptacle 20 is once again pressed against the free end 18 of the ring seal such that the sealing of the axial region is completed. The radial portion of the seal is produced by the rounding 16 that is respectively pressed against the collar 21 and against the collar 31 of the inner receptacle 30.

Another stopping point is realized with the aid of the groove 14 in the ring seal 10 that receives the collar 35 of the receptacle 30. (See also FIG. 2b).

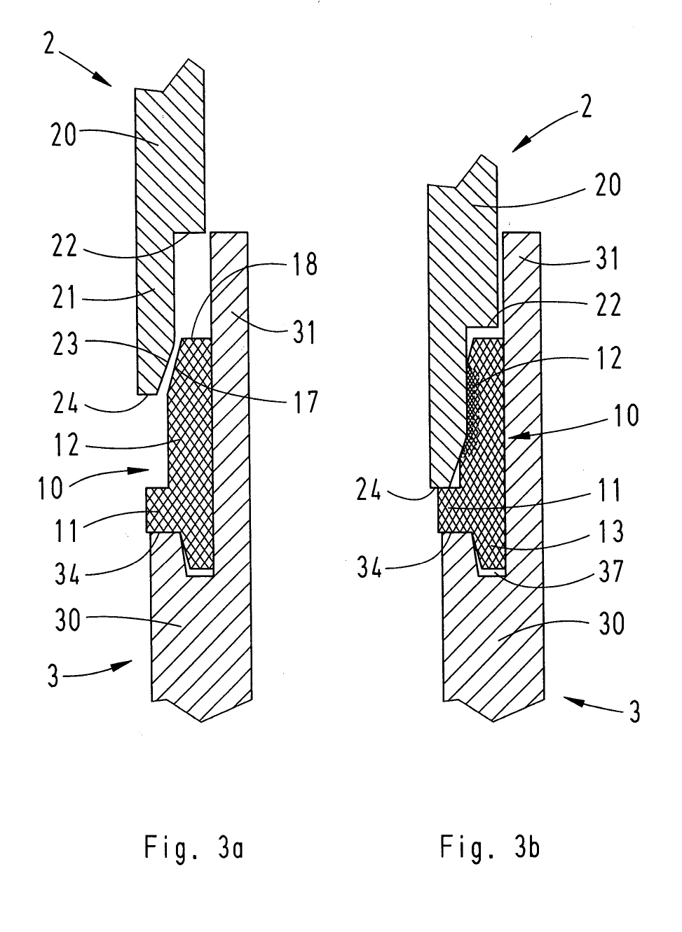

FIGS. 3a and 3b also show two different illustrations for elucidating the connecting process.

This figure shows a second variation of a ring seal 10 that is placed around the collar 31 of the receptacle 30 and inserted and glued into a peripheral gap 37 with a conically shaped end 13. Above the conical end, the ring seal lies on the outer end stop 34 of the receptacle 30 with the axial sealing region 11—a projecting, nearly square part of the ring seal.

The collar 21 of the receptacle 20 features a slope 23 that encounters a slope 17 of the ring seal 10 during the connecting process. As the connecting process progresses, the outer wall of the ring seal is increasingly compressed by the passing wall of the collar 21 until the end stop 24 lies on the axial sealing region 11 as shown in FIG. 3b.

As described above with reference to FIG. 2, the end stop side 24 of the receptacle 20 that is relatively narrow due to the slope 23 encounters the axial portion 11 of the ring seal while the radial seal is produced due to the compression of the ring seal by the collars 21 and 31.

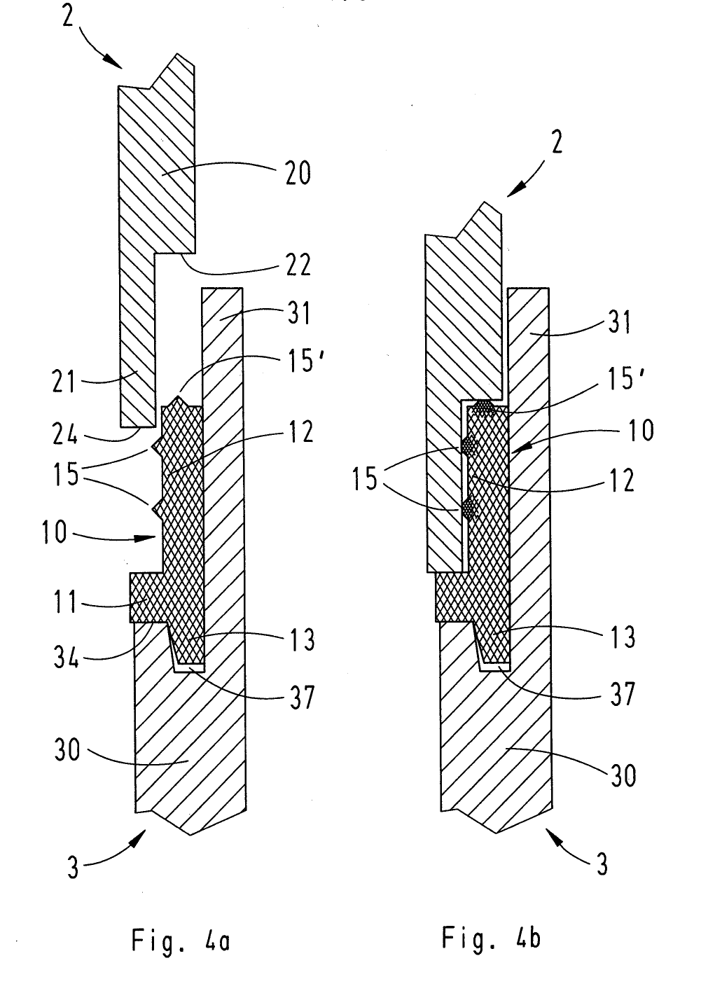

FIGS. 4a and 4b show a third variation of a basically “flat” ring seal 10 with an integral axial sealing region 11 that lies on the end stop 34.

The ring seal 10 is placed around the collar 31 of the receptacle 30 and inserted and glued into a peripheral gap 37 with its conically shaped end 13.

A total of three sealing lips are integrally formed onto the radial sealing region 12, wherein two sealing lips 15 act radially outward and one sealing lip 15′ acts axially in the connecting direction and is integrally formed onto the narrow side situated opposite of the conical end 13.

During the connecting process, the two radially acting sealing lips 15 of the ring seal 10 are initially pressed against the inner side of the collar 21 of the receptacle 20 until the end stop 22 ultimately also acts upon the axially acting sealing lip 15′. Consequently, the requirement of an axially and radially acting seal between the two receptacles is fulfilled.

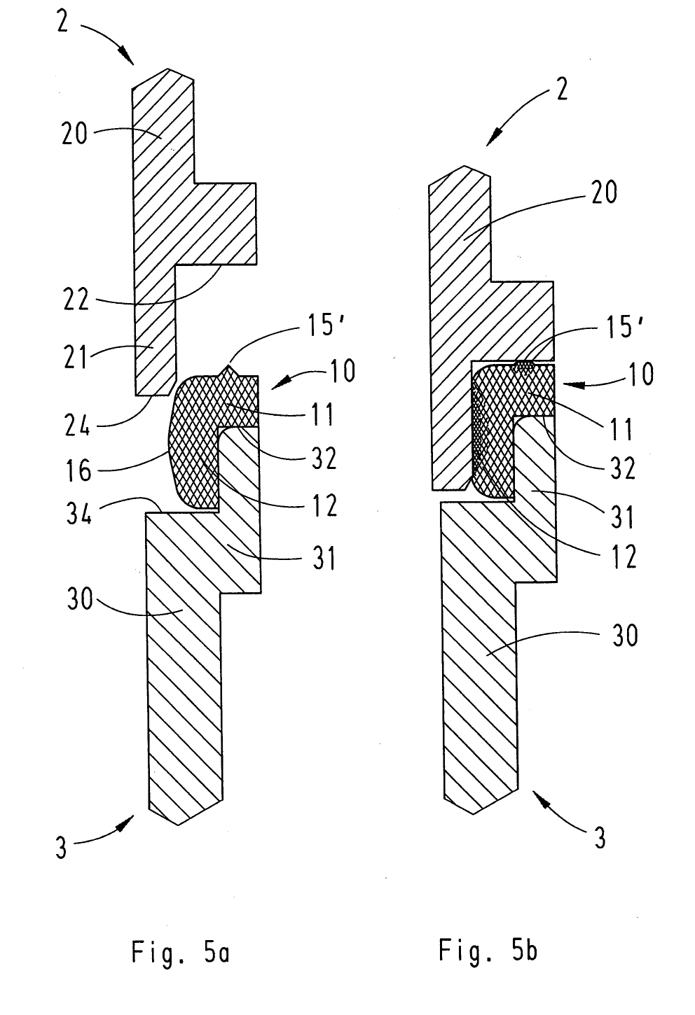

FIGS. 5a and 5b show a fourth variation, in which an L-shaped ring seal 10 is attached and glued to the receptacle 30.

In this case, a peripheral sealing lip 15′ that acts in the connecting direction is provided on the limb for the axial sealing region 11 of the ring seal. This sealing lip is realized in a pyramid-shaped fashion in order to ensure a reliable seal with the least expenditure of force possible.

The limb for the radial sealing region 12 points laterally outward and is provided with a rounding 16 that is compressed during the connection of the collar 21 on the receptacle 20 to the receptacle 30. This means that the radial portion of the seal is also produced in this case while the axial portion of the seal is realized with the end stop 22 on the sealing lip 15′.

What is claimed is:

1. A housing seal for a plug-type connection that is composed of a connector and a mating connector and respectively features a receptacle, wherein a ring seal is fixed on the receptacle features an axial sealing region and a radial sealing region.

2. The housing seal according to claim 1, wherein the ring seal is fixed on a collar of the receptacle by means of a groove.

3. The housing seal according to claim 1, wherein a conical end is integrally formed onto the ring seal.

4. The housing seal according to at least one of the preceding claims, wherein the ring seal features at least one peripheral, radially acting sealing lip.

5. The housing seal according to at least one of the preceding claims, wherein the ring seal features a peripheral, axially acting sealing lip.

6. The housing seal according to at least one of the preceding claims, wherein the ring seal is glued into a gap in the receptacle.

7. The housing seal according to at least one of the preceding claims, wherein the ring seal features an outwardly directed rounding.

8. The housing seal according to at least one of the preceding claims, wherein the ring seal features a slope.
